(19) United States
(12) Patent Application Publication
(10) Pub. No.: US 2015/0212292 A1
(43) Pub. Date: Jul. 30, 2015

(54) MOBILE DEVICE AND OPTICAL IMAGING LENS THEREOF

(71) Applicant: GeniuS Electronic Optical Co., Ltd., Taichung City (TW)

(72) Inventors: Shih Han CHEN, Taichung City (TW); Chung Chih CHANG, Taichung City (TW); Feng CHEN, Fujian (CN)

(21) Appl. No.: 14/297,780

(22) Filed: Jun. 6, 2014

(30) Foreign Application Priority Data
Jan. 27, 2014 (CN) 201410039589.6

(51) Int. Cl. G02B 13/00; H04N 5/225

(52) U.S. Cl. CPC G02B 13/0015; G02B 13/0045; H04N 5/2252; H04N 5/2254

(57) ABSTRACT

Present embodiments provide for a mobile device and an optical imaging lens thereof. The optical imaging lens comprises five lens elements positioned sequentially from an object side to an image side and an aperture stop positioned before the first lens element. Through controlling the convex or concave shape of the surfaces of the lens elements and designing parameters satisfying an inequality, the optical imaging lens shows better optical characteristics and the total length of the optical imaging lens is shortened.

### INCORPORATION BY REFERENCE

This application claims priority from P.R.C. Patent Application No. 201410039589.6, filed on Jan. 27, 2014, the contents of which are hereby incorporated by reference in their entirety for all purposes.

### TECHNICAL FIELD

The present invention relates to a mobile device and an optical imaging lens thereof, and particularly, relates to a mobile device applying an optical imaging lens having five lens elements and an optical imaging lens thereof.

### BACKGROUND

The ever-increasing demand for smaller sized mobile devices, such as cell phones, digital cameras, etc. correspondingly triggered a growing need for a smaller sized photography module, comprising elements such as an optical imaging lens, a module housing unit, and an image sensor, etc., contained therein. Size reductions may be contributed from various aspects of the mobile devices, which includes not only the charge coupled device (CCD) and the complementary metal-oxide semiconductor (CMOS), but also the optical imaging lens mounted therein. When reducing the size of the optical imaging lens, however, achieving good optical characteristics becomes a challenging problem.

The length of conventional optical imaging lenses comprising four lens elements can be limited in a certain range; however, as the more and more demands in the market for high-end products, high-standard optical imaging lenses which show great quality with more pixels are required.

U.S. Pat. Nos. 7,480,105, 7,639,432, 7,486,449 and 7,684,127 all disclosed an optical imaging lens constructed with an optical imaging lens having five lens elements. The transition of the refracting power of the first two lens elements in the '105 and '432 patents are negative-positive, and that in the '449 and '127 patents are negative-negative; however, such configurations are not able to generate good optical characteristics. The length of the optical imaging lens, which, from the object-side surface of the first lens element to the image plane, in these patents are within 10˜18 mm. These optical imaging lenses are too long for smaller sized mobile devices.

U.S. Pat. Nos. 8,233,224, 8,363,337 and 8,000,030 all disclosed an optical imaging lens constructed with an optical imaging lens having five lens elements. The transition of the refracting power of the first two lens elements in these patents are positive-negative, which is better than negative-positive or negative-negative of the four patents listed above. However, the surface shape of the third to fifth lens elements cannot satisfy the requirements of adjusting aberration and shortening the length of the optical imaging lens. The length of the optical imaging lens, which, from the object-side surface of the first lens element to the image plane, in some of these patents are greater than 6 mm. These optical imaging lenses are still too long for smaller sized mobile devices.

Therefore, there is needed to develop optical imaging lens which is capable to place with five lens elements therein, with a shorter length, while also having good optical characteristics.

### SUMMARY

An object of the present invention is to provide a mobile device and an optical imaging lens thereof. With controlling the convex or concave shape of the surfaces and an inequality, the length of the optical imaging lens is shortened and meanwhile the good optical characteristics, and system functionality are sustained.

In an exemplary embodiment, an optical imaging lens comprises, sequentially from an object side to an image side along an optical axis, comprises an aperture stop, first, second, third, fourth and fifth lens elements, each of the first, second, third, fourth and fifth lens elements having refracting power, an object-side surface facing toward the object side and an image-side surface facing toward the image side and a central thickness defined along the optical axis.

In the specification, parameters used here are: the central thickness of the first lens element, represented by T1, an air gap between the first lens element and the second lens element along the optical axis, represented by AG12, the central thickness of the second lens element, represented by T2, an air gap between the second lens element and the third lens element along the optical axis, represented by AG23, the central thickness of the third lens element, represented by T3, an air gap between the third lens element and the fourth lens element along the optical axis, represented by AG34, the central thickness of the fourth lens element, represented by T4, an air gap between the fourth lens element and the fifth lens element along the optical axis, represented by AG45, the central thickness of the fifth lens element, represented by T5, a distance between the image-side surface of the fifth lens element and the object-side surface of a filtering unit along the optical axis, represented by G5F, the central thickness of the filtering unit along the optical axis, represented by TF, a distance between the image-side surface of the filtering unit and an image plane along the optical axis, represented by GFP, a focusing length of the first lens element, represented by f1, a focusing length of the second lens element, represented by f2, a focusing length of the third lens element, represented by f3, a focusing length of the fourth lens element, represented by f4, a focusing length of the fifth lens element, represented by f5, the refracting power of the first lens element, represented by n1, the refracting power of the second lens element, represented by n2, the refracting power of the third lens element, represented by n3, the refracting power of the fourth lens element, represented by n4, the refracting power of the fifth lens element, represented by n5, an abbe number of the first lens element, represented by v1, an abbe number of the second lens element, represented by v2, an abbe number of the third lens element, represented by v3, an abbe number of the fourth lens element, represented by v4, an abbe number of the fifth lens element, represented by v5, an effective focal length of the optical imaging lens, represented by EFL, the length between the object-side surface of the first lens element and the image plane along the optical axis, represented by TTL, a sum of the central thicknesses of all five lens elements, represented by ALT, a sum of all four air gaps from the first lens element to the fifth lens element along the optical axis, represented by AAG, and a back focal length of the optical imaging lens, which is defined as the distance from the image-side surface of the fifth lens element to the image plane along the optical axis and represented by BFL.

In the optical imaging lens of the present invention, the first lens element has positive refracting power, and the object-side surface thereof is a convex surface comprising a convex portion in a vicinity of the optical axis and a convex portion in a vicinity of a periphery of the first lens element; the second lens element has negative refracting power, and the image-side surface thereof comprises a concave portion in a vicinity of a periphery of the second lens element; the object-side surface of the third lens element comprises a convex portion in a vicinity of a periphery of the third lens element; the fourth lens element has positive refracting power, and the object-side surface thereof comprises a concave portion in a vicinity of a periphery of the fourth lens element, and the image-side surface thereof is a convex surface comprising a convex portion in a vicinity of the optical axis and a convex portion in a vicinity of the periphery of the fourth lens element; the image-side surface of the fifth lens element comprises a concave portion in a vicinity of the optical axis and a convex portion in a vicinity of a periphery of the fifth lens element; the optical imaging lens comprises no other lenses having reflecting power beyond the five lens elements; and an air gap between the third lens element and the fourth lens element along the optical axis is represented by AG34, an air gap between the fourth lens element and the fifth lens element along the optical axis is represented by AG45, and AG34 and AG45 satisfy the equation:

AG34/AG45≦2.2 Equation (1).

In another exemplary embodiment, other equation(s), such as those relating to the ratio among parameters could be taken into consideration. For example, AG45 and T2 could be controlled to satisfy the equation as follows:

0.6≦T2/AG45 Equation(2); or

AG34 and AG23 could be controlled to satisfy the equation as follows:

0.4≦AG23/AG34 Equation (3); or

T2 and T5 could be controlled to satisfy the equation as follows:

0.5≦T2/T5 Equation (4); or

AG34 and T1 could be controlled to satisfy the equation as follows:

1.3≦T1/AG34 Equation(5); or

AAG and BFL could be controlled to satisfy the equation as follows:

0.79≦AAG/BFL Equation (6); or

T2 and AG23 could be controlled to satisfy the equation as follows:

0.8≦AG23/T2 Equation (7); or

T4 and ALT could be controlled to satisfy the equation as follows:

3.3≦ALT/T4 Equation (8); or

AG34 and T3 could be controlled to satisfy the equation as follows:

0.95≦T3/AG34 Equation (9); or

AG34 and BFL could be controlled to satisfy the equation as follows:

0.3≦AG34/BFL Equation (10); or

T3 and AG45 could be controlled to satisfy the equation as follows:

1≦T3/AG45 Equation (11);or

AG34 and AAG could be controlled to satisfy the equation as follows:

2.6≦AAG/AG34 Equation(12); or

T5 and AG34 could be controlled to satisfy the equation as follows:

0.64≦AG34/T5 Equation (13).

Aforesaid exemplary embodiments are not limited and could be selectively incorporated in other embodiments described herein.

In some exemplary embodiments, more details about the convex or concave surface structure could be incorporated for one specific lens element or broadly for plural lens elements to enhance the control for the system performance and/or resolution. It is noted that the details listed here could be incorporated in example embodiments if no inconsistency occurs.

In another exemplary embodiment, a mobile device comprising a housing and a photography module positioned in the housing is provided. The photography module comprises any of aforesaid example embodiments of optical imaging lens, a lens barrel, a module housing unit and an image sensor. The lens barrel is for positioning the optical imaging lens, the module housing unit is for positioning the lens barrel, and the image sensor is positioned at the image side of the optical imaging lens.

Through controlling the convex or concave shape of the surfaces and/or the refraction power of the lens element(s), the mobile device and the optical imaging lens thereof in exemplary embodiments achieve good optical characteristics and effectively shorten the length of the optical imaging lens.

### BRIEF DESCRIPTION OF THE DRAWINGS

Exemplary embodiments will be more readily understood from the following detailed description when read in conjunction with the appended drawing, in which:

FIG. 1 is a cross-sectional view of one single lens element according to the present disclosure;

FIG. 2 is a cross-sectional view of a first embodiment of an optical imaging lens having five lens elements according to the present disclosure;

FIG. 3 is a chart of longitudinal spherical aberration and other kinds of optical aberrations of a first embodiment of the optical imaging lens according to the present disclosure;

FIG. 4 is a table of optical data for each lens element of a first embodiment of an optical imaging lens according to the present disclosure;

FIG. 5 is a table of aspherical data of a first embodiment of the optical imaging lens according to the present disclosure;

FIG. 6 is a cross-sectional view of a second embodiment of an optical imaging lens having five lens elements according to the present disclosure;

FIG. 7 is a chart of longitudinal spherical aberration and other kinds of optical aberrations of a second embodiment of the optical imaging lens according to the present disclosure;

FIG. 8 is a table of optical data for each lens element of the optical imaging lens of a second embodiment of the present disclosure;

FIG. 9 is a table of aspherical data of a second embodiment of the optical imaging lens according to the present disclosure;

FIG. 10 is a cross-sectional view of a third embodiment of an optical imaging lens having five lens elements according to the present disclosure;

FIG. 11 is a chart of longitudinal spherical aberration and other kinds of optical aberrations of a third embodiment of the optical imaging lens according the present disclosure;

FIG. 12 is a table of optical data for each lens element of the optical imaging lens of a third embodiment of the present disclosure;

FIG. 13 is a table of aspherical data of a third embodiment of the optical imaging lens according to the present disclosure;

FIG. 14 is a cross-sectional view of a fourth embodiment of an optical imaging lens having five lens elements according to the present disclosure;

FIG. 15 is a chart of longitudinal spherical aberration and other kinds of optical aberrations of a fourth embodiment of the optical imaging lens according the present disclosure;

FIG. 16 is a table of optical data for each lens element of the optical imaging lens of a fourth embodiment of the present disclosure;

FIG. 17 is a table of aspherical data of a fourth embodiment of the optical imaging lens according to the present disclosure;

FIG. 18 is a cross-sectional view of a fifth embodiment of an optical imaging lens having five lens elements according to the present disclosure;

FIG. 19 is a chart of longitudinal spherical aberration and other kinds of optical aberrations of a fifth embodiment of the optical imaging lens according the present disclosure;

FIG. 20 is a table of optical data for each lens element of the optical imaging lens of a fifth embodiment of the present disclosure;

FIG. 21 is a table of aspherical data of a fifth embodiment of the optical imaging lens according to the present disclosure;

FIG. 22 is a cross-sectional view of a sixth embodiment of an optical imaging lens having five lens elements according to the present disclosure;

FIG. 23 is a chart of longitudinal spherical aberration and other kinds of optical aberrations of a sixth embodiment of the optical imaging lens according the present disclosure;

FIG. 24 is a table of optical data for each lens element of the optical imaging lens of a sixth embodiment of the present disclosure;

FIG. 25 is a table of aspherical data of a sixth embodiment of the optical imaging lens according to the present disclosure;

FIG. 26 is a table for the values of AG34/AG45, T2/AG45, AG23/AG34, T2/T5, T1/AG34, AAG/BFL, AG23/T2, ALT/T4, T3/AG34, AG34/BFL, T3/AG45, AAG/AG34, AG34/T5 of all six example embodiments;

FIG. 27 is a structure of an example embodiment of a mobile device;

FIG. 28 is a partially enlarged view of the structure of another example embodiment of a mobile device.

### DETAILED DESCRIPTION

For a more complete understanding of the present disclosure and its advantages, reference is now made to the following description taken in conjunction with the accompanying drawings, in which like reference numbers indicate like features. Persons having ordinary skill in the art will understand other varieties for implementing example embodiments, including those described herein. The drawings are not limited to specific scale and similar reference numbers are used for representing similar elements. As used in the disclosures and the appended claims, the terms “example embodiment,” “exemplary embodiment,” and “present embodiment” do not necessarily refer to a single embodiment, although it may, and various example embodiments may be readily combined and interchanged, without departing from the scope or spirit of the present invention. Furthermore, the terminology as used herein is for the purpose of describing example embodiments only and is not intended to be a limitation of the invention. In this respect, as used herein, the term “in” may include “in” and “on”, and the terms “a”, “an” and “the” may include singular and plural references. Furthermore, as used herein, the term “by” may also mean “from”, depending on the context. Furthermore, as used herein, the term “if” may also mean “when” or “upon”, depending on the context. Furthermore, as used herein, the words “and/or” may refer to and encompass any and all possible combinations of one or more of the associated listed items.

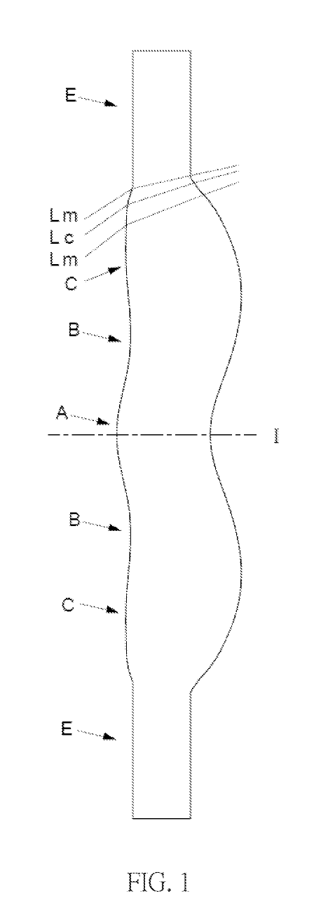

Here in the present specification, “a lens element having positive refracting power (or negative refracting power)” means that the lens element has positive refracting power (or negative refracting power) in the vicinity of the optical axis. “An object-side (or image-side) surface of a lens element comprises a convex (or concave) portion in a specific region” means that the object-side (or image-side) surface of the lens element “protrudes outwardly (or depresses inwardly)” along the direction parallel to the optical axis at the specific region, compared with the outer region radially adjacent to the specific region. Taking FIG. 1 for example, the lens element shown therein is radially symmetric around the optical axis which is labeled by I. The object-side surface of the lens element comprises a convex portion at region A, a concave portion at region B, and another convex portion at region C. This is because compared with the outer region radially adjacent to the region A (i.e. region B), the object-side surface protrudes outwardly at the region A, compared with the region C, the object-side surface depresses inwardly at the region B, and compared with the region E, the object-side surface protrudes outwardly at the region C. Here, “in a vicinity of a periphery of a lens element” means that in a vicinity of the peripheral region of a surface for passing imaging light on the lens element, i.e. the region C as shown in FIG. 1. The imaging light comprises chief ray Lc and marginal ray Lm. “In a vicinity of the optical axis” means that in a vicinity of the optical axis of a surface for passing the imaging light on the lens element, i.e. the region A as shown in FIG. 1. Further, a lens element could comprise an extending portion E for mounting the lens element in an optical imaging lens. Ideally, the imaging light would not pass the extending portion E. Here the extending portion E is only for example, the structure and shape thereof are not limited to this specific example. Please also noted that the extending portion of all the lens elements in the example embodiments shown below are skipped for maintaining the drawings clean and concise.

In the present invention, examples of an optical imaging lens which is a prime lens are provided. Example embodiments of an optical imaging lens may comprise an aperture stop, a first lens element, a second lens element, a third lens element, a fourth lens element and a fifth lens element, each of the lens elements comprises refracting power, an object-side surface facing toward an object side and an image-side surface facing toward an image side and a central thickness defined along the optical axis. These lens elements may be arranged sequentially from the object side to the image side along an optical axis, and example embodiments of the lens may comprise no other lenses having reflecting power beyond the five lens elements. In an example embodiment: the first lens element has positive refracting power, and the object-side surface thereof is a convex surface comprising a convex portion in a vicinity of the optical axis and a convex portion in a vicinity of a periphery of the first lens element; the second lens element has negative refracting power, and the image-side surface thereof comprises a concave portion in a vicinity of a periphery of the second lens element; the object-side surface of the third lens element comprises a convex portion in a vicinity of a periphery of the third lens element; the fourth lens element has positive refracting power, and the object-side surface thereof comprises a concave portion in a vicinity of a periphery of the fourth lens element, and the image-side surface thereof is a convex surface comprising a convex portion in a vicinity of the optical axis and a convex portion in a vicinity of the periphery of the fourth lens element; the image-side surface of the fifth lens element comprises a concave portion in a vicinity of the optical axis and a convex portion in a vicinity of a periphery of the fifth lens element; and an air gap between the third lens element and the fourth lens element along the optical axis is represented by AG34, an air gap between the fourth lens element and the fifth lens element along the optical axis is represented by AG45, and AG34 and AG45 satisfy the equation:

AG34/AG45≦2.2 Equation (1).

Preferably, the lens elements are designed in light of the optical characteristics and the length of the optical imaging lens. For example, the first lens element having positive refracting power is able to provide the most refracting power of the optical imaging lens, the second lens element having negative refracting power is able to adjust aberration, the fourth lens element having positive refracting power is able to share the required positive refracting power of the optical imaging lens to decrease the difficulty in design and manufacture process. Additionally, the aperture stop positioned before the first lens element may assist in collecting light to shorten the length of the optical imaging lens. Then, the convex object-side surface of the first lens element may also assist in collecting light, and combining this with the details of shape on the surfaces of the lens elements listed here, such as the concave portion in a vicinity of a periphery of the second lens element formed on the image-side surface thereof, the convex portion in a vicinity of a periphery of the third lens element formed on the object-side surface thereof, the concave portion in a vicinity of a periphery of the fourth lens element formed on the object-side surface thereof, the convex image-side surface of the fourth lens element, the concave portion in a vicinity of the optical axis formed on the image-side surface of the fifth lens element and/or the convex portion in a vicinity of a periphery of the fifth lens element formed on the image-side surface thereof, the aberration of the optical imaging lens could be further adjusted to promote the imaging quality of the optical imaging lens.

In another exemplary embodiment, some equation(s) of parameters, such as those relating to the ratio among parameters could be taken into consideration. For example, AG45 and T2 could be controlled to satisfy the equation as follows:

0.6≦T2/AG45 Equation(2); or

AG34 and AG23 could be controlled to satisfy the equation as follows:

0.4≦AG23/AG34 Equation(3); or

T2 and T5 could be controlled to satisfy the equation as follows:

0.5≦T2/T5 Equation (4); or

AG34 and T1 could be controlled to satisfy the equation as follows:

1.3≦T1/AG34 Equation (5); or

AAG and BFL could be controlled to satisfy the equation as follows:

0.79≦AAG/BFL Equation (6); or

T2 and AG23 could be controlled to satisfy the equation as follows:

0.8≦AG23/T2 Equation(7); or

T4 and ALT could be controlled to satisfy the equation as follows:

3.3≦ALT/T4 Equation(8); or

AG34 and T3 could be controlled to satisfy the equation as follows:

0.95≦T3/AG34 Equation(9); or

AG34 and BFL could be controlled to satisfy the equation as follows:

0.3≦AG34/BFL Equation(10); or

T3 and AG45 could be controlled to satisfy the equation as follows:

1≦T3/AG45 Equation(11);or

AG34 and AAG could be controlled to satisfy the equation as follows:

2.6≦AAG/AG34 Equation (12);or

T5 and AG34 could be controlled to satisfy the equation as follows:

0.64≦AG34/T5 Equation (13).

Aforesaid exemplary embodiments are not limited and could be selectively incorporated in other embodiments described herein.

Reference is now made to Equations (1), (3) and (12). Considering that a proper ratio between the values of AG23, AG34, AG45 and AAG is beneficial to avoid any excessive value which may hinder the shortening of the length of the optical imaging lens or extreme small value to hinder the assembly process, here the value of AG34/AG45 is suggested for an upper limit, such as 2.2 to satisfy Equation (1), and preferably, it is suggested to be within 0.5˜2.2, the value of AG23/AG34 is suggested for a lower limit, such as 0.4 to satisfy Equation (3), and preferably, it is suggested to be within 0.4˜1.5, and the value of AAG/AG34 is suggested for a lower limit, such as 2.6 to satisfy Equation (12), and preferably, it is suggested to be within 2.6˜3.5.

Reference is now made to Equations (6) and (10). Considering that the excessive BFL is quite a hinder for shortening the length of the optical imaging lens, AAG/BFL and AG34/BFL are preferred to be great values. Here, the value of AAG/BFL is suggested for a lower limit, such as 0.79 to satisfy Equation (6), and preferably, it is suggested to be within 0.79˜1.4, and the value of AG34/BFL is suggested for a lower limit, such as 0.3 to satisfy Equation (10), and preferably, it is suggested to be within 0.3˜0.5.

Reference is now made to Equations (2) and (11). Considering that the shortening of T2, T3 and AG45 may assist in shortening the length of the optical imaging lens and AG45 is required for sustaining a certain distance between the fourth and fifth lens element to expand imaging light to a proper level for promoting imaging quality, here T2/AG45 is suggested for a lower limit, such as 0.6 to satisfy Equation (2), and preferably, it is suggested to be within 0.6˜2.0, and T3/AG45 is suggested for a lower limit, such as 1.0 to satisfy Equation (11), and preferably, it is suggested to be within 1.0˜3.0.

Reference is now made to Equations (5) and (9). Considering that the value of AG34 easily become excessive due to the concave portion in a vicinity of a periphery of the fourth lens element formed on the object-side surface thereof, these equations are beneficial to shortening the length of the optical imaging lens by controlling the value of AG34. Here, the value of T1/AG34 is suggested for a lower limit, such as 1.3 to satisfy Equation (5), and preferably, it is suggested to be within 1.3˜2.5, and the value of T3/AG34 is suggested for a lower limit, such as 0.95 to satisfy Equation (9), and preferably, it is suggested to be within 0.95˜1.5.

Reference is now made to Equations (4) and (13). Considering that the shortening of T5 may assist in shortening the length of the optical imaging lens as well as promoting the adjustment of the aberration, here the value of T2/T5 is suggested for a lower limit, such as 0.5 to satisfying Equation (4), and preferably, it is suggested to be limited by a lower limit, such as within 0.5˜0.7, and the value of AG34/T5 is suggested for a lower limit, such as 0.64 to satisfying Equation (13), and preferably, it is suggested to be limited by a lower limit, such as within 0.64˜1.4.

Reference is now made to Equations (7), (8) and (9). Considering that configuring proper value for the air gaps between each lens element is beneficial to avoid any excessive value or extreme small value, both of which may result in unlike problem in assembly or manufacturing process, here the value of AG23/T2 is suggested to be limited by a lower limit, such as 0.8, and preferably, it is suggested to be within 0.8˜2.5, the value of ALT/T4 is suggested to be limited by a lower limit, such as 3.3, and preferably, it is suggested to be within 3.3˜4.5, and the value of T3/AG45 is suggested to be limited by a lower limit, such as 1.0, and preferably, it is suggested to be within 1.0˜3.0.

In light of the unpredictability in an optical system, in the present invention, satisfying these equation listed above may preferably shortening the length of the optical imaging lens, lowering the f-number, enlarging the shot angle, promoting the imaging quality and/or increasing the yield in the assembly process.

When implementing example embodiments, more details about the convex or concave surface could be incorporated for one specific lens element or broadly for plural lens elements to enhance the control for the system performance and/or resolution. It is noted that the details listed here could be incorporated in example embodiments if no inconsistency occurs.

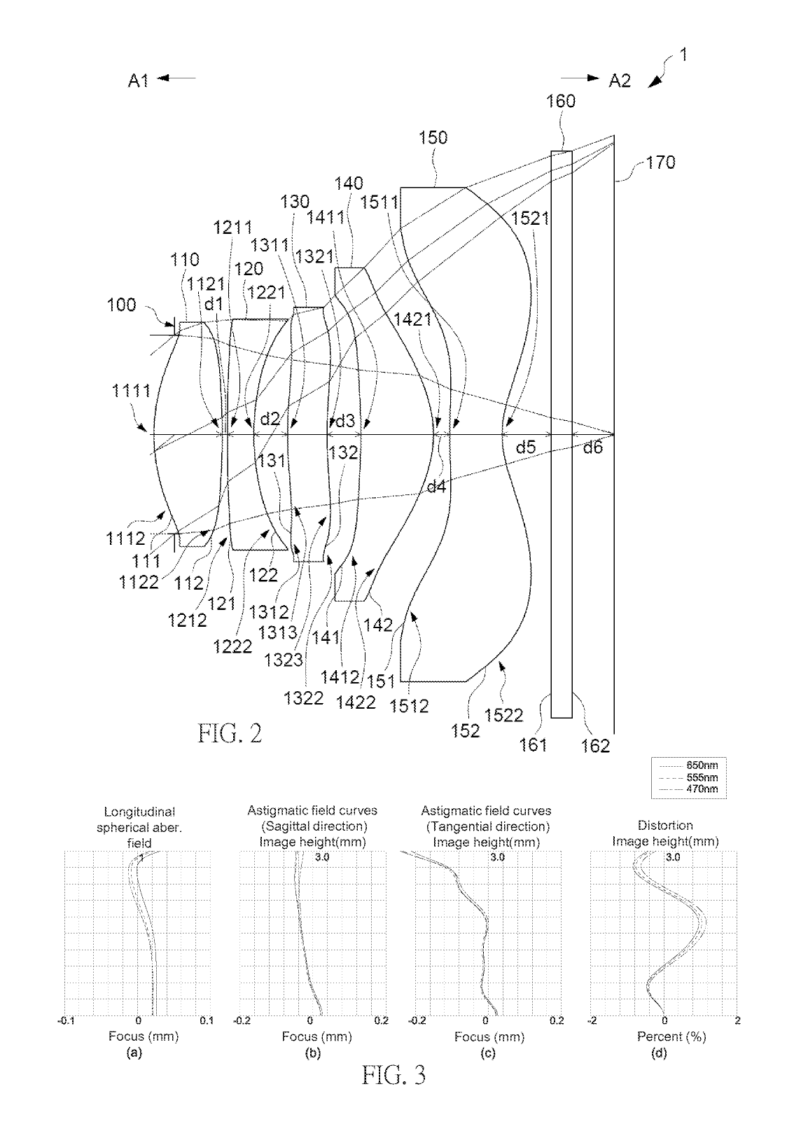

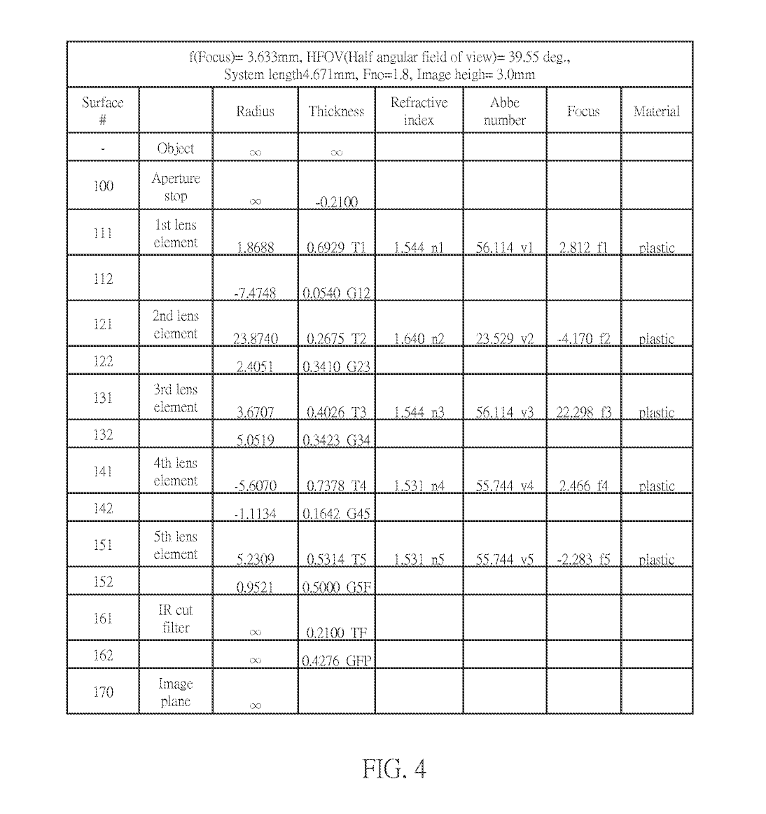

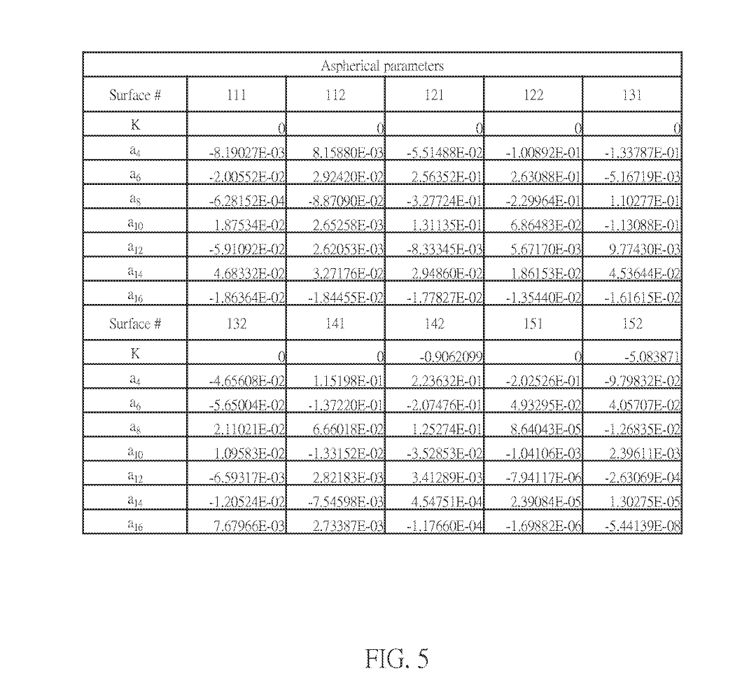

Several exemplary embodiments and associated optical data will now be provided for illustrating example embodiments of optical imaging lens with good optical characteristics and a shortened length. Reference is now made to FIGS. 2-5. FIG. 2 illustrates an example cross-sectional view of an optical imaging lens 1 having five lens elements of the optical imaging lens according to a first example embodiment. FIG. 3 shows example charts of longitudinal spherical aberration and other kinds of optical aberrations of the optical imaging lens 1 according to an example embodiment. FIG. 4 illustrates an example table of optical data of each lens element of the optical imaging lens 1 according to an example embodiment, in which f is used for representing EFL. FIG. 5 depicts an example table of aspherical data of the optical imaging lens 1 according to an example embodiment.

As shown in FIG. 2, the optical imaging lens 1 of the present embodiment comprises, in order from an object side A1 to an image side A2 along an optical axis, an aperture stop 100, a first lens element 110, a second lens element 120, a third lens element 130, a fourth lens element 140 and a fifth lens element 150. A filtering unit 160 and an image plane 170 of an image sensor are positioned at the image side A2 of the optical lens 1. Each of the first, second, third, fourth, fifth lens elements 110, 120, 130, 140, 150 and the filtering unit 160 comprises an object-side surface 111/121/131/141/151/161 facing toward the object side A1 and an image-side surface 112/122/132/142/152/162 facing toward the image side A2. The example embodiment of the filtering unit 160 illustrated is an IR cut filter (infrared cut filter) positioned between the fifth lens element 150 and an image plane 170. The filtering unit 160 selectively absorbs light with specific wavelength from the light passing optical imaging lens 1. For example, IR light is absorbed, and this will prohibit the IR light which is not seen by human eyes from producing an image on the image plane 170.

Please noted that during the normal operation of the optical imaging lens 1, the distance between any two adjacent lens elements of the first, second, third, fourth, and fifth lens elements 110, 120, 130, 140, 150 is a unchanged value, i.e. the optical imaging lens 1 is a prime lens.

Exemplary embodiments of each lens element of the optical imaging lens 1 which may be constructed by plastic material will now be described with reference to the drawings.

An example embodiment of the first lens element 110 has positive refracting power. The object-side surface 111 is a convex surface comprising a convex portion 1111 in a vicinity of the optical axis and a convex portion 1112 in a vicinity of a periphery of the first lens element 110. The image-side surface 112 is a convex surface comprising a convex portion 1121 in a vicinity of the optical axis and a convex portion 1122 in a vicinity of the periphery of the first lens element 110.

An example embodiment of the second lens element 120 has negative refracting power. The object-side surface 121 is a convex surface comprising a convex portion 1211 in a vicinity of the optical axis and a convex portion 1212 in a vicinity of a periphery of the second lens element 120. The image-side surface 122 is a concave surface comprising a concave portion 1221 in a vicinity of the optical axis and a concave portion 1222 in a vicinity of the periphery of the second lens element 120.

An example embodiment of the third lens element 130 has positive refracting power. The object-side surface 131 comprises a convex portion 1311 in a vicinity of the optical axis, a convex portion 1312 in a vicinity of a periphery of the third lens element 130 and a concave portion 1313 between the region in a vicinity of the optical axis and the region in a vicinity of the periphery of the third lens element 130. The image-side surface 132 comprises a concave portion 1321 in a vicinity of the optical axis, a concave portion 1322 in a vicinity of the periphery of the third lens element 130 and a convex portion 1323 between the region in a vicinity of the optical axis and the region in a vicinity of the periphery of the third lens element 130.

An example embodiment of the fourth lens element 140 has positive refracting power. The object-side surface 141 is a concave surface comprising a concave portion 1411 in a vicinity of the optical axis and a concave portion 1412 in a vicinity of a periphery of the fourth lens element 140. The image-side surface 142 is a convex surface comprising a convex portion 1421 in a vicinity of the optical axis and a convex portion 1422 in a vicinity of the periphery of the fourth lens element 140.

An example embodiment of the fifth lens element 150 has negative refracting power. The object-side surface 151 comprises a convex portion 1511 in a vicinity of the optical axis and a concave portion 1512 in a vicinity of a periphery of the fifth lens element 150. The image-side surface 152 comprises a concave portion 1521 in a vicinity of the optical axis and a convex portion 1522 in a vicinity of the periphery of the fifth lens element 150.

In example embodiments, air gaps exist between the lens elements 110, 120, 130, 140, 150, the filtering unit 160 and the image plane 170 of the image sensor. For example, FIG. 1 illustrates the air gap d1 existing between the first lens element 110 and the second lens element 120, the air gap d2 existing between the second lens element 120 and the third lens element 130, the air gap d3 existing between the third lens element 130 and the fourth lens element 140, the air gap d4 existing between the fourth lens element 140 and the fifth lens element 150, the air gap d5 existing between the fifth lens element 150 and the filtering unit 160 and the air gap d6 existing between the filtering unit 160 and the image plane 170 of the image sensor. However, in other embodiments, any of the aforesaid air gaps may or may not exist. For example, the profiles of opposite surfaces of any two adjacent lens elements may correspond to each other, and in such situation, the air gap may not exist. The air gap d1 is denoted by AG12, the air gap d2 is denoted by AG23, the air gap d3 is denoted by AG34, the air gap d4 is denoted by AG45 and the sum of d1, d2, d3 and d4 is denoted by AAG.

FIG. 4 depicts the optical characteristics of each lens elements in the optical imaging lens 1 of the present embodiment, wherein the values of AG34/AG45, T2/AG45, AG23/AG34, T2/T5, T1/AG34, AAG/BFL, AG23/T2, ALT/T4, T3/AG34, AG34/BFL, T3/AG45, AAG/AG34, AG34/T5 are:

AG34/AG45=2.084;

T2/AG45=1.629;

AG23/AG34=0.996;

T2/T5=0.503;

T1/AG34=2.024;

AAG/BFL=0.792;

AG23/T2=1.275;

ALT/T4=3.567;

T3/AG34=1.176;

AG34/BFL=0.301;

T3/AG45=2.452;

AAG/AG34=2.634;

AG34/T5=0.644.

The distance from the object-side surface 111 of the first lens element 110 to the image plane 170 along the optical axis is 4.671 mm, and the length of the optical imaging lens 1 is shortened. Thus, the optical imaging lens 1 is capable to provide excellent imaging quality for smaller sized mobile devices. Please noted that the f-number of the optical imaging lens 1 reaches 1.8 and this is beneficial to shot in a low illuminating environment.

The aspherical surfaces, including the object-side surface 111 and the image-side surface 112 of the first lens element 110, the object-side surface 121 and the image-side surface 122 of the second lens element 120, the object-side surface 131 and the image-side surface 132 of the third lens element 130, the object-side surface 141 and the image-side surface 142 of the fourth lens element 140, the object-side

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{i} \times {Y}^{i}$$

surface 151 and the image-side surface 152 of the fifth lens element 150 are all defined by the following aspherical formula:

wherein,

R represents the radius of curvature of the surface of the lens element;

Z represents the depth of the aspherical surface (the perpendicular distance between the point of the aspherical surface at a distance Y from the optical axis and the tangent plane of the vertex on the optical axis of the aspherical surface);

Y represents the perpendicular distance between the point of the aspherical surface and the optical axis;

K represents a conic constant;

aᵢ represents an aspherical coefficient of i^{th} level.

The values of each aspherical parameter are shown in FIG. 5.

As illustrated in FIG. 3, longitudinal spherical aberration (a), the curves of different wavelengths are closed to each other. This represents off-axis light with respect to these wavelengths is focused around an image point. From the vertical deviation of each curve shown therein, the offset of the off-axis light relative to the image point is within ±0.04 mm. Therefore, the present embodiment improves the longitudinal spherical aberration with respect to different wavelengths.

Please refer to FIG. 3, astigmatism aberration in the sagittal direction (b) and astigmatism aberration in the tangential direction (c). The focus variation with respect to the three wavelengths in the whole field falls within ±0.26 mm. This reflects the optical imaging lens 1 of the present embodiment eliminates aberration effectively. Additionally, the closed curves represents dispersion is improved.

Please refer to FIG. 3, distortion aberration (d), which showing the variation of the distortion aberration is within ±1.2%.

Therefore, the optical imaging lens 1 of the present embodiment shows great characteristics in the longitudinal spherical aberration, astigmatism in the sagittal direction, astigmatism in the tangential direction, and distortion aberration. According to above illustration, the optical imaging lens 1 of the example embodiment indeed achieves great optical performance and the length of the optical imaging lens 1 is effectively shortened.

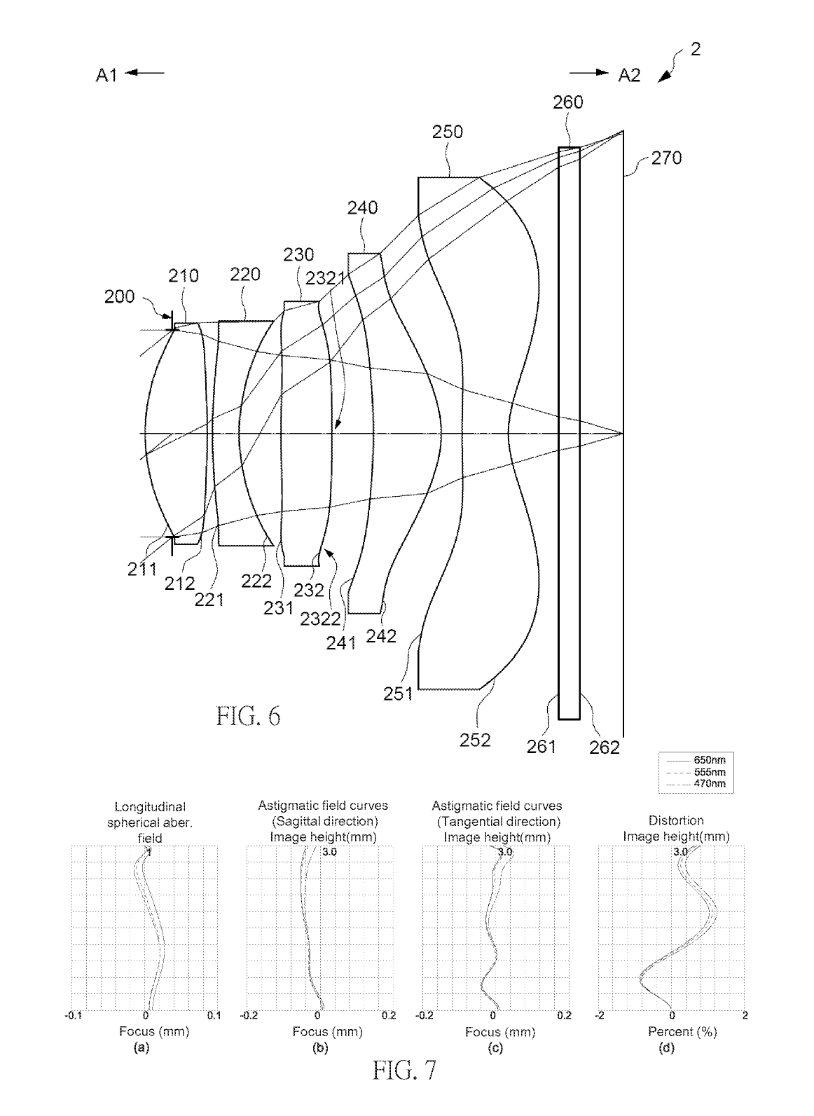

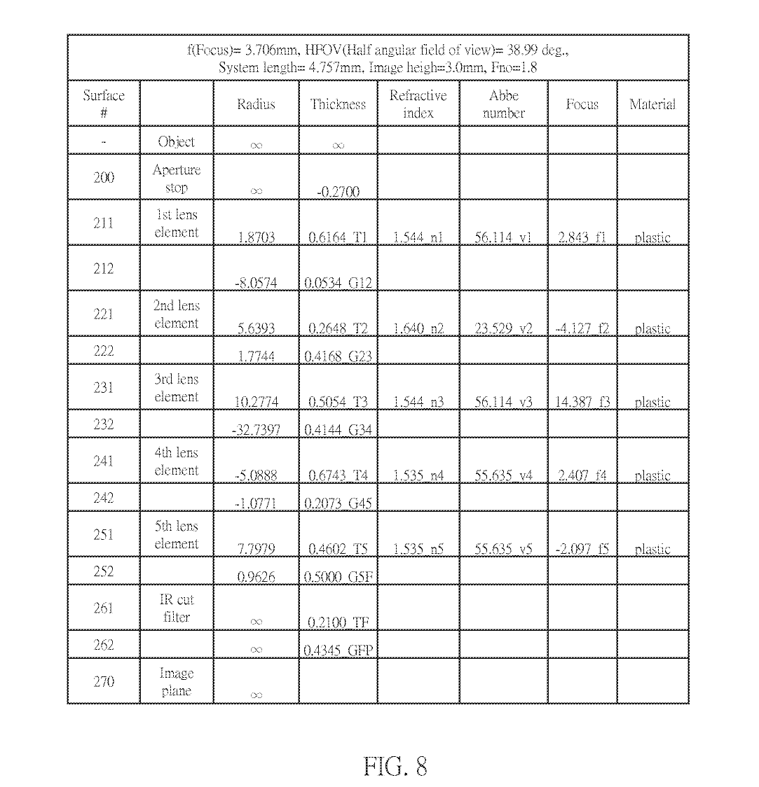

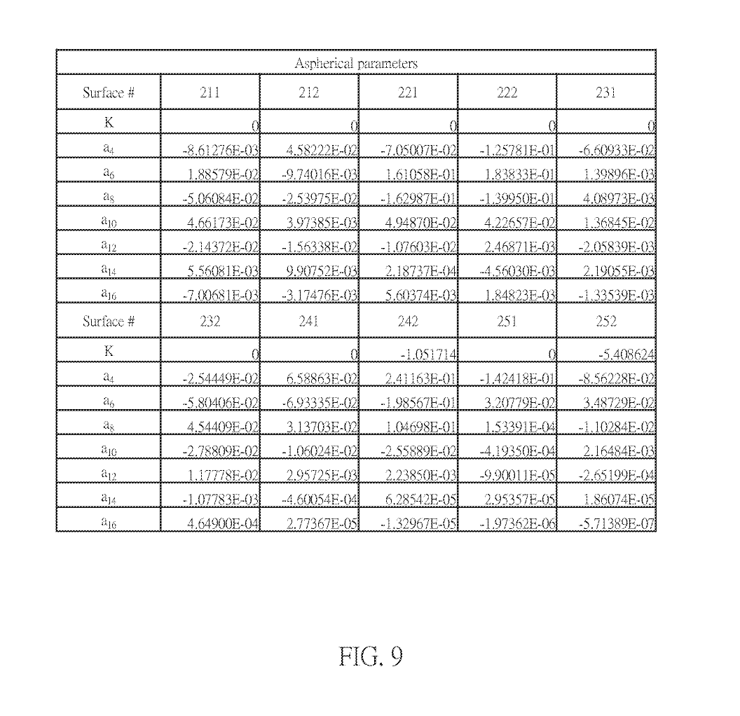

Reference is now made to FIGS. 6-9. FIG. 6 illustrates an example cross-sectional view of an optical imaging lens 2 having five lens elements of the optical imaging lens according to a second example embodiment. FIG. 7 shows example charts of longitudinal spherical aberration and other kinds of optical aberrations of the optical imaging lens 2 according to the second example embodiment. FIG. 8 shows an example table of optical data of each lens element of the optical imaging lens 2 according to the second example embodiment. FIG. 9 shows an example table of aspherical data of the optical imaging lens 2 according to the second example embodiment. The reference numbers labeled in the present embodiment are similar to those in the first embodiment for the similar elements, but here the reference numbers are initialed with 2, for example, reference number 231 for labeling the object-side surface of the third lens element 230, reference number 232 for labeling the image-side surface of the third lens element 230, etc..

As shown in FIG. 6, the optical imaging lens 2 of the present embodiment, in an order from an object side A1 to an image side A2 along an optical axis, comprises an aperture stop 200, a first lens element 210, a second lens element 220, a third lens element 230, a fourth lens element 240 and a fifth lens element 250.

The differences between the second embodiment and the first embodiment are the radius of curvature and thickness of each lens element, the distance of each air gap and the configuration of the concave/convex shape of the image-side surface 232, but the configuration of the positive/negative refracting power of the first, second, third, fourth and fifth lens elements 210, 220, 230, 240, 250 and configuration of the concave/convex shape of surfaces, comprising the object-side surfaces 211, 221, 231, 241, 251 facing to the object side A1 and the image-side surfaces 212, 222, 242, 252 facing to the image side A2, are similar to those in the first embodiment. Specifically, the image-side surface 232 of the third lens element 230 only comprises a convex portion 2321 in a vicinity of the optical axis and a concave portion 2322 in a vicinity of a periphery of the third lens element 230. Please refer to FIG. 8 for the optical characteristics of each lens elements in the optical imaging lens 2 the present embodiment, the values of AG34/AG45, T2/AG45, AG23/AG34, T2/T5, T1/AG34, AAG/BFL, AG23/T2, ALT/T4, T3/AG34, AG34/BFL, T3/AG45, AAG/AG34, AG34/T5 are:

AG34/AG45=1.999;

T2/AG45=1.277;

AG23/AG34=1.006;

T2/T5=0.575;

T1/AG34=1.488;

AAG/BFL=0.954;

AG23/T2=1.574;

ALT/T4=3.739;

T3/AG34=1.220;

AG34/BFL=0.362;

T3/AG45=2.438;

AAG/AG34=2.635;

AG34/T5=0.901.

The distance from the object-side surface 211 of the first lens element 210 to the image plane 270 along the optical axis is 4.757 mm and the length of the optical imaging lens 2 is shortened. Thus, the optical imaging lens 2 is capable to provide excellent imaging quality for smaller sized mobile devices. Please noted that the f-number of the optical imaging lens 2 reaches 1.8.

As shown in FIG. 7, the optical imaging lens 2 of the present embodiment shows great characteristics in longitudinal spherical aberration (a), astigmatism in the sagittal direction (b), astigmatism in the tangential direction (c), and distortion aberration (d), and the present embodiment shows a better characteristics in the astigmatism in the tangential direction (c) than that of the first embodiment to provide a better imaging quality. Therefore, according to the above illustration, the optical imaging lens of the present embodiment indeed shows great optical performance and the length of the optical imaging lens 2 is effectively shortened.

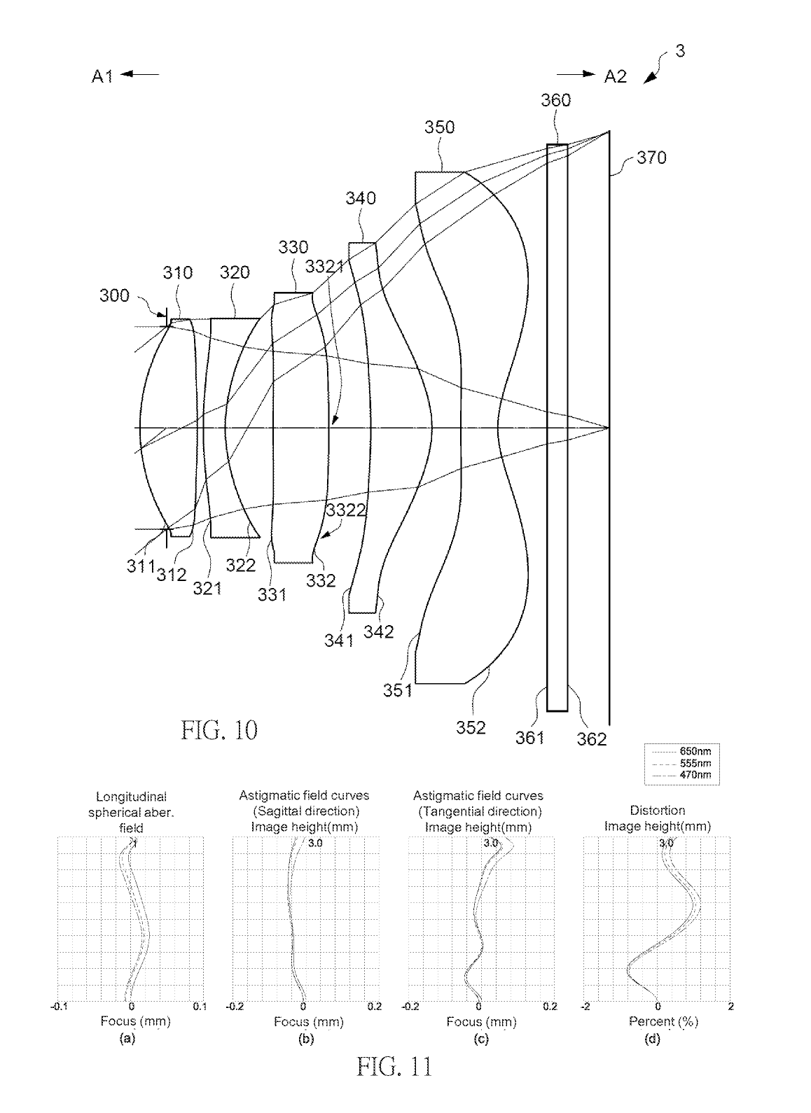

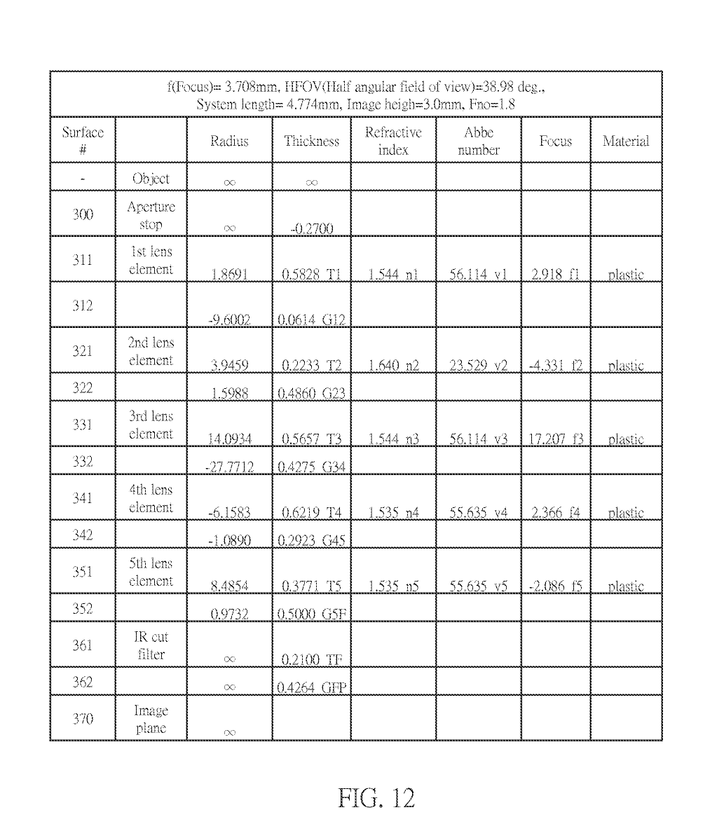

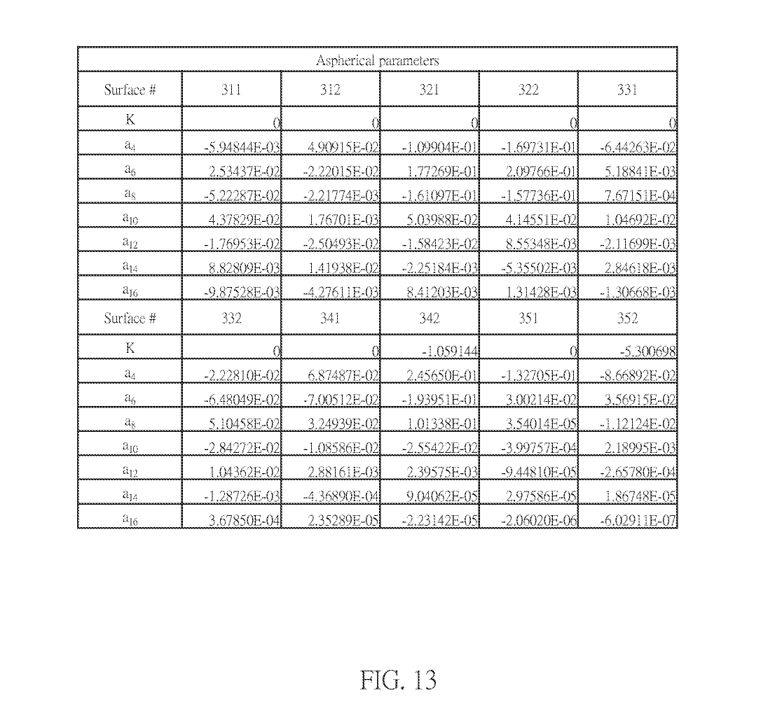

Reference is now made to FIGS. 10-13. FIG. 10 illustrates an example cross-sectional view of an optical imaging lens 3 having five lens elements of the optical imaging lens according to a third example embodiment. FIG. 11 shows example charts of longitudinal spherical aberration and other kinds of optical aberrations of the optical imaging lens 3 according to the third example embodiment. FIG. 12 shows an example table of optical data of each lens element of the optical imaging lens 3 according to the third example embodiment. FIG. 13 shows an example table of aspherical data of the optical imaging lens 3 according to the third example embodiment. The reference numbers labeled in the present embodiment are similar to those in the first embodiment for the similar elements, but here the reference numbers are initialed with 3, for example, reference number 331 for labeling the object-side surface of the third lens element 330, reference number 332 for labeling the image-side surface of the third lens element 330, etc..

As shown in FIG. 10, the optical imaging lens 3 of the present embodiment, in an order from an object side A1 to an image side A2 along an optical axis, comprises an aperture stop 300, a first lens element 310, a second lens element 320, a third lens element 330, a fourth lens element 340 and a fifth lens element 350.

The differences between the third embodiment and the first embodiment are the radius of curvature and thickness of each lens element, the distance of each air gap and the surface shape of the image-side surface 332 but the configuration of the positive/negative refracting power of the first, second, third, fourth and fifth lens elements 310, 320, 330, 340, 350 and configuration of the concave/convex shape of surfaces, comprising the object-side surfaces 311, 321, 331, 341, 351 facing to the object side A1 and the image-side surfaces 312, 322, 342, 352 facing to the image side A2, are similar to those in the first embodiment. Specifically, the image-side surface 332 of the third lens element 330 only comprises a convex portion 3321 in a vicinity of the optical axis and a concave portion 3322 in a vicinity of a periphery of the third lens element 330. Please refer to FIG. 12 for the optical characteristics of each lens elements in the optical imaging lens 3 of the present embodiment, wherein the values of AG34/AG45, T2/AG45, AG23/AG34, T2/T5, T1/AG34, AAG/BFL, AG23/T2, ALT/T4, T3/AG34, AG34/BFL, T3/AG45, AAG/AG34, AG34/T5 are:

AG34/AG45=1.462;

T2/AG45=0.764;

AG23/AG34=1.137;

T2/T5=0.592;

T1/AG34=1.363;

AAG/BFL=1.115;

AG23/T2=2.176;

ALT/T4=3.812;

T3/AG34=1.323;

AG34/BFL=0.376;

T3/AG45=1.935;

AAG/AG34=2.964;

AG34/T5=1.133.

The distance from the object-side surface 311 of the first lens element 310 to the image plane 370 along the optical axis is 4.774 mm and the length of the optical imaging lens 3 is shortened. Thus, the optical imaging lens 3 is capable to provide excellent imaging quality for smaller sized mobile devices. Please noted that the f-number of the optical imaging lens 3 reaches 1.8.

As shown in FIG. 11, the optical imaging lens 3 of the present embodiment shows great characteristics in longitudinal spherical aberration (a), astigmatism in the sagittal direction (b), astigmatism in the tangential direction (c), and distortion aberration (d), and the present embodiment shows a better characteristics in the astigmatism in the tangential direction (c) than that of the first embodiment to provide a better imaging quality. Therefore, according to the above illustration, the optical imaging lens of the present embodiment indeed shows great optical performance and the length of the optical imaging lens 3 is effectively shortened.

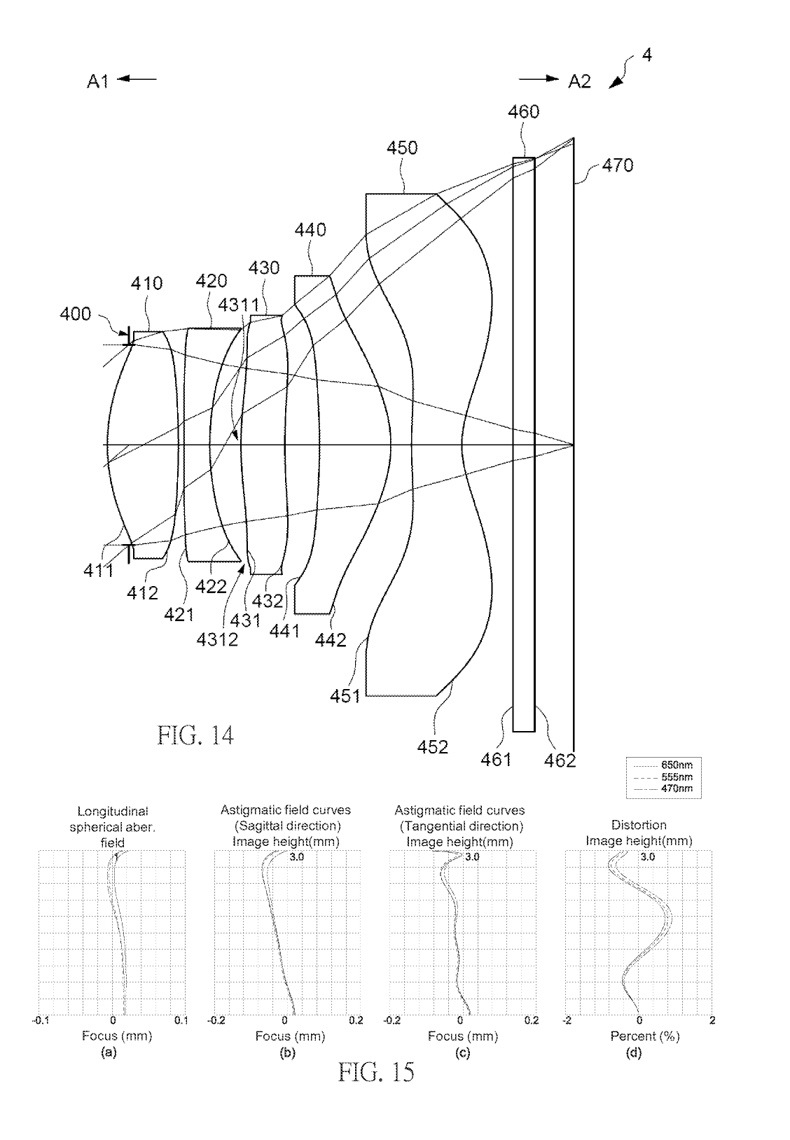

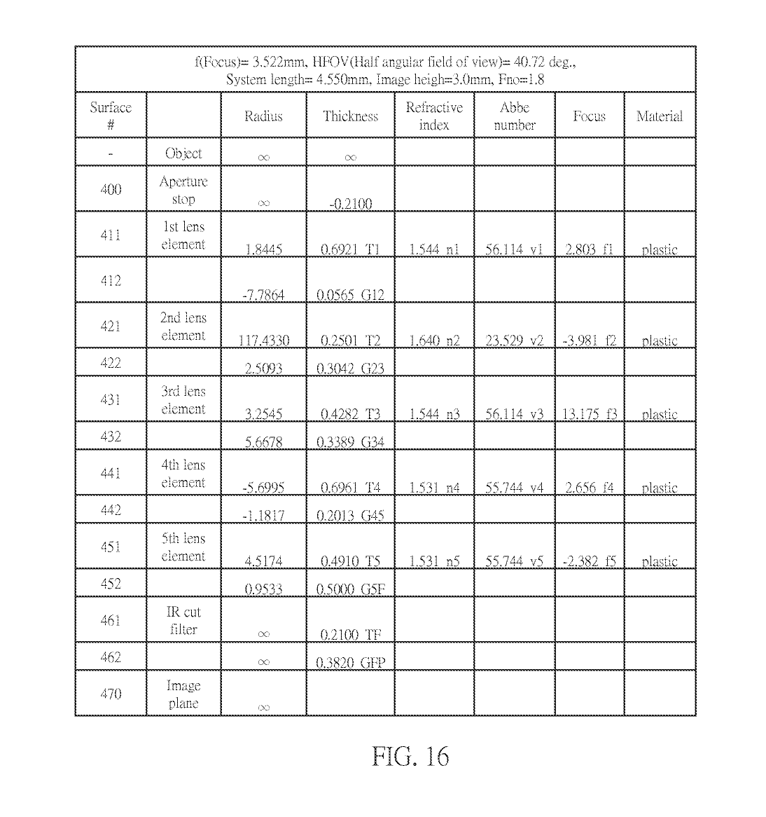

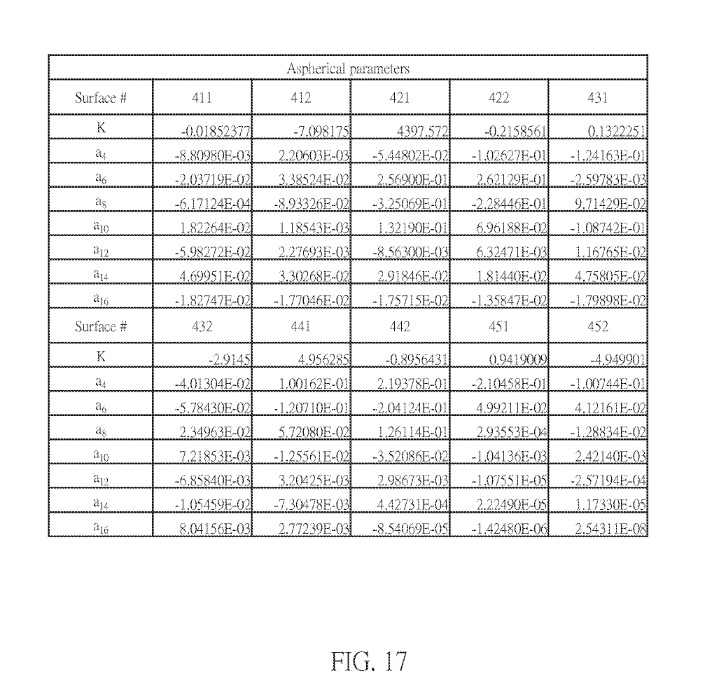

Reference is now made to FIGS. 14-17. FIG. 14 illustrates an example cross-sectional view of an optical imaging lens 4 having five lens elements of the optical imaging lens according to a fourth example embodiment. FIG. 15 shows example charts of longitudinal spherical aberration and other kinds of optical aberrations of the optical imaging lens 4 according to the fourth embodiment. FIG. 16 shows an example table of optical data of each lens element of the optical imaging lens 4 according to the fourth example embodiment. FIG. 17 shows an example table of aspherical data of the optical imaging lens 4 according to the fourth example embodiment. The reference numbers labeled in the present embodiment are similar to those in the first embodiment for the similar elements, but here the reference numbers are initialed with 4, for example, reference number 431 for labeling the object-side surface of the third lens element 430, reference number 432 for labeling the image-side surface of the third lens element 430, etc..

As shown in FIG. 14, the optical imaging lens 4 of the present embodiment, in an order from an object side A1 to an image side A2 along an optical axis, comprises an aperture stop 400, a first lens element 410, a second lens element 420, a third lens element 430, a fourth lens element 440 and a fifth lens element 450.

The differences between the fourth embodiment and the first embodiment are the radius of curvature and thickness of each lens element, the distance of each air gap and the configuration of the concave/convex shape of the object-side surface 431, but the configuration of the positive/negative refracting power of the first, second, third, fourth and fifth lens elements 410, 420, 430, 440, 450 and configuration of the concave/convex shape of surfaces, comprising the object-side surfaces 411, 421, 441, 451 facing to the object side A1 and the image-side surfaces 412, 422, 432, 442, 452 facing to the image side A2, are similar to those in the first embodiment. Specifically, the object-side surface 431 of the third lens element 430 only comprises a convex portion 4311 in a vicinity of the optical axis and a concave portion 4312 in a vicinity of a periphery of the third lens element 430. Please refer to FIG. 16 for the optical characteristics of each lens elements in the optical imaging lens 4 of the present embodiment, wherein the values of AG34/AG45, T2/AG45, AG23/AG34, T2/T5, T1/AG34, AAG/BFL, AG23/T2, ALT/T4, T3/AG34, AG34/BFL, T3/AG45, AAG/AG34, AG34/T5 are:

AG34/AG45=1.683;

T2/AG45=1.242;

AG23/AG34=0.898;

T2/T5=0.509;

T1/AG34=2.042;

AAG/BFL=0.825;

AG23/T2=1.216;

ALT/T4=3.674;

T3/AG34=1.264;

AG34/BFL=0.310;

T3/AG45=2.127;

AAG/AG34=2.658;

AG34/T5=0.690.

The distance from the object-side surface 411 of the first lens element 410 to the image plane 470 along the optical axis is 4.550 mm and the length of the optical imaging lens 4 is shortened. Thus, the optical imaging lens 4 is capable to provide excellent imaging quality for smaller sized mobile devices. Please noted that the f-number of the optical imaging lens 4 reaches 1.8.

As shown in FIG. 15, the optical imaging lens 4 of the present embodiment shows great characteristics in longitudinal spherical aberration (a), astigmatism in the sagittal direction (b), astigmatism in the tangential direction (c), and distortion aberration (d), and the present embodiment shows a better characteristics in the astigmatism in the tangential direction (c) than that of the first embodiment to provide a better imaging quality. Therefore, according to the above illustration, the optical imaging lens of the present embodiment indeed shows great optical performance and the length of the optical imaging lens 4 is effectively shortened.

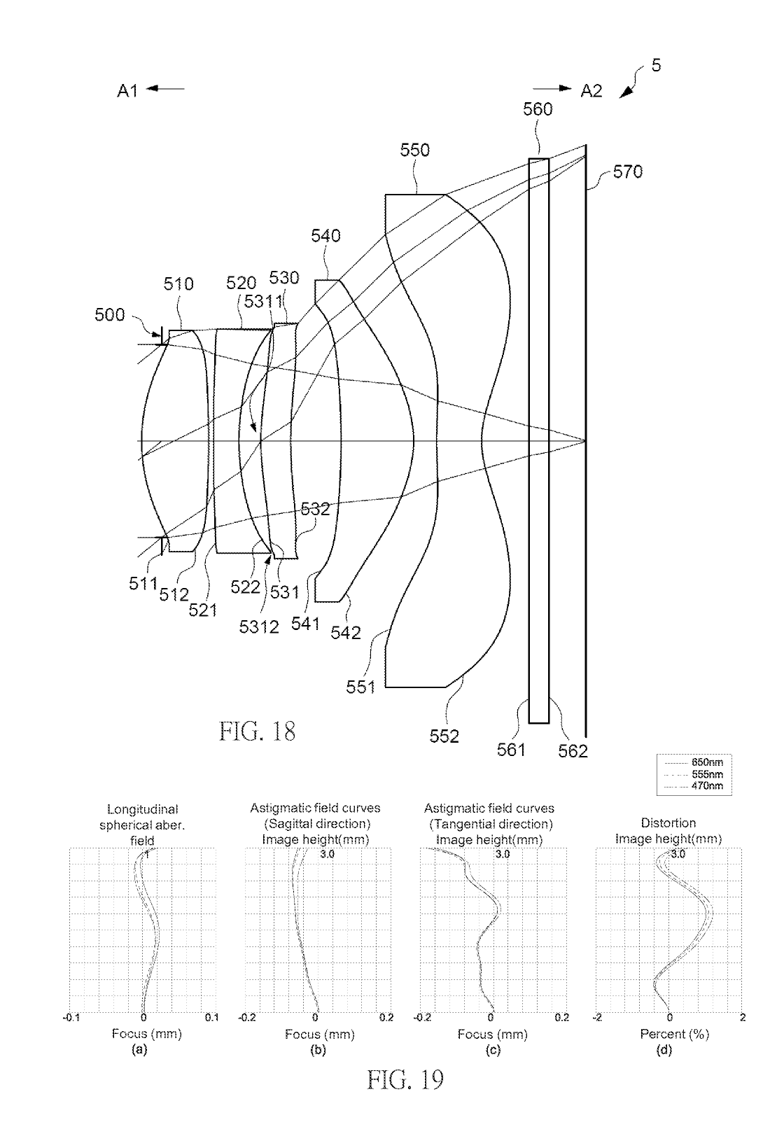

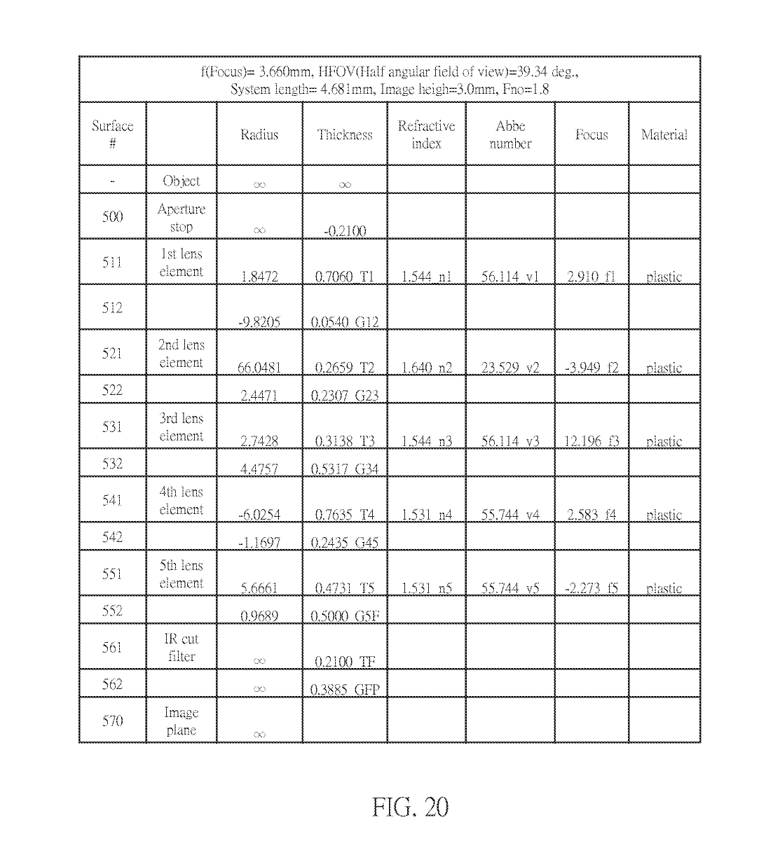

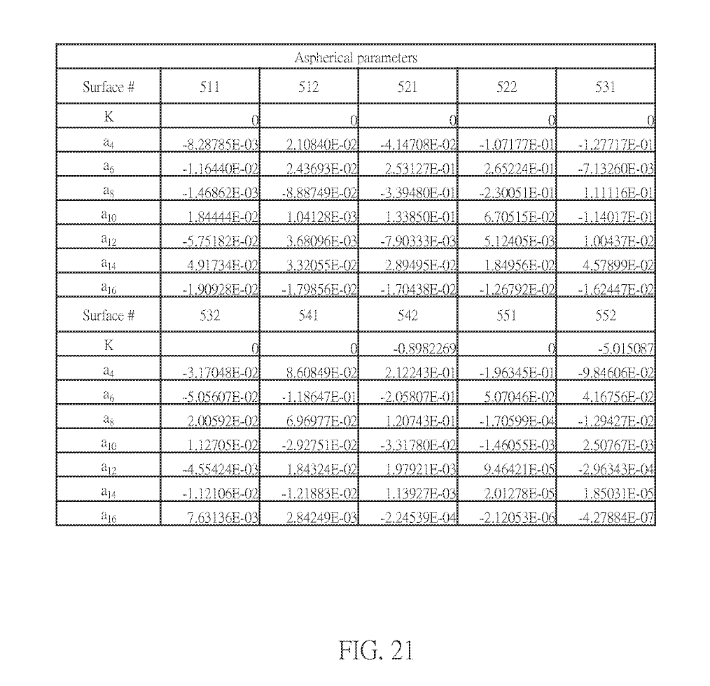

Reference is now made to FIGS. 18-21. FIG. 18 illustrates an example cross-sectional view of an optical imaging lens 5 having five lens elements of the optical imaging lens according to a fifth example embodiment. FIG. 19 shows example charts of longitudinal spherical aberration and other kinds of optical aberrations of the optical imaging lens 5 according to the fifth embodiment. FIG. 20 shows an example table of optical data of each lens element of the optical imaging lens 5 according to the fifth example embodiment. FIG. 21 shows an example table of aspherical data of the optical imaging lens 5 according to the fifth example embodiment. The reference numbers labeled in the present embodiment are similar to those in the first embodiment for the similar elements, but here the reference numbers are initialed with 5, for example, reference number 531 for labeling the object-side surface of the third lens element 530, reference number 532 for labeling the image-side surface of the third lens element 530, etc..

As shown in FIG. 18, the optical imaging lens 5 of the present embodiment, in an order from an object side A1 to an image side A2 along an optical axis, comprises an aperture stop 500, a first lens element 510, a second lens element 520, a third lens element 530, a fourth lens element 540 and a fifth lens element 550.

The differences between the fifth embodiment and the first embodiment are the radius of curvature and thickness of each lens element, the distance of each air gap and the configuration of the concave/convex shape of the object-side surface 531, but the configuration of the positive/negative refracting power of the first, second, third, fourth and fifth lens elements 510, 520, 530, 540, 550 and configuration of the concave/convex shape of surfaces, comprising the object-side surfaces 511, 521, 541, 551 facing to the object side A1 and the image-side surfaces 512, 522, 532, 542, 552 facing to the image side A2, are similar to those in the first embodiment. Specifically, the object-side surface 531 of the third lens element 530 only comprises a convex portion 5311 in a vicinity of the optical axis and a convex portion 5312 in a vicinity of a periphery of the third lens element 530. Please refer to FIG. 20 for the optical characteristics of each lens elements in the optical imaging lens 5 of the present embodiment, wherein the values of AG34/AG45, T2/AG45, AG23/AG34, T2/T5, T1/AG34, AAG/BFL, AG23/T2, ALT/T4, T3/AG34, AG34/BFL, T3/AG45, AAG/AG34, AG34/T5 are:

AG34/AG45=2.183;

T2/AG45=1.092;

AG23/AG34=0.434;

T2/T5=0.562;

T1/AG34=1.328;

AAG/BFL=0.965;

AG23/T2=0.868;

ALT/T4=3.304;

T3/AG34=0.590;

AG34/BFL=0.484;

T3/AG45=1.289;

AAG/AG34=1.994;

AG34/T5=1.124.

The distance from the object-side surface 511 of the first lens element 510 to the image plane 570 along the optical axis is 4.681 mm and the length of the optical imaging lens 5 is shortened. Thus, the optical imaging lens 5 is capable to provide excellent imaging quality for smaller sized mobile devices. Please noted that the f-number of the optical imaging lens 5 reaches 1.8.

As shown in FIG. 19, the optical imaging lens 5 of the present embodiment shows great characteristics in longitudinal spherical aberration (a), astigmatism in the sagittal direction (b), astigmatism in the tangential direction (c), and distortion aberration (d), and the present embodiment shows a better characteristics in the astigmatism in the tangential direction (c) than that of the first embodiment to provide a better imaging quality. Therefore, according to the above illustration, the optical imaging lens of the present embodiment indeed shows great optical performance and the length of the optical imaging lens 5 is effectively shortened.

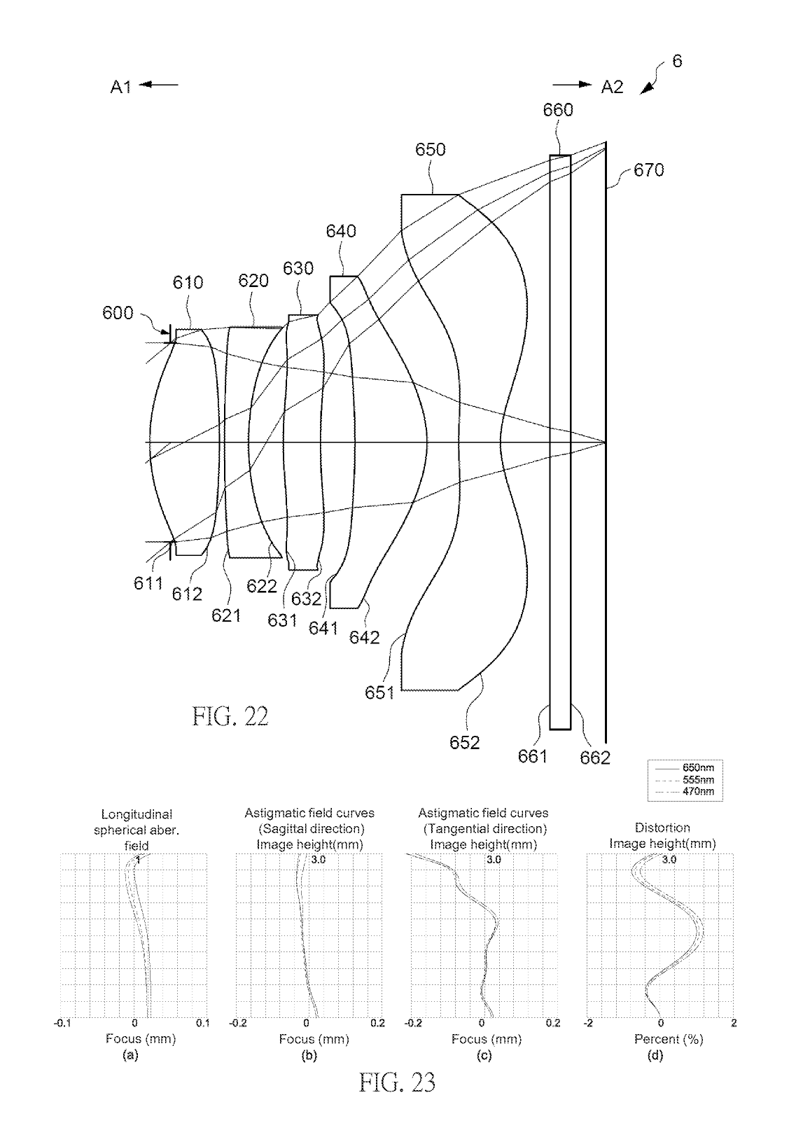

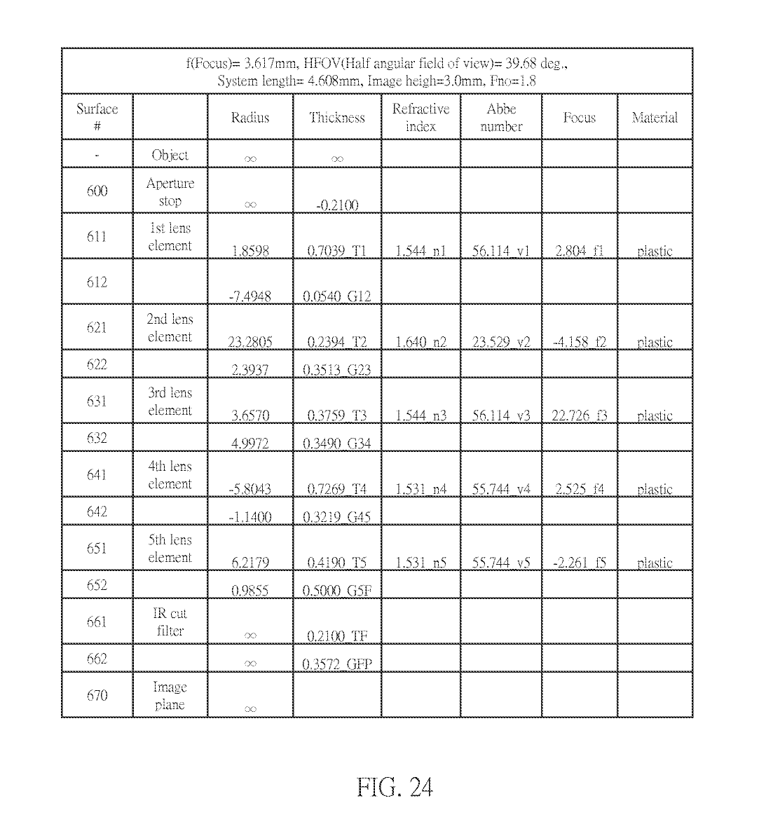

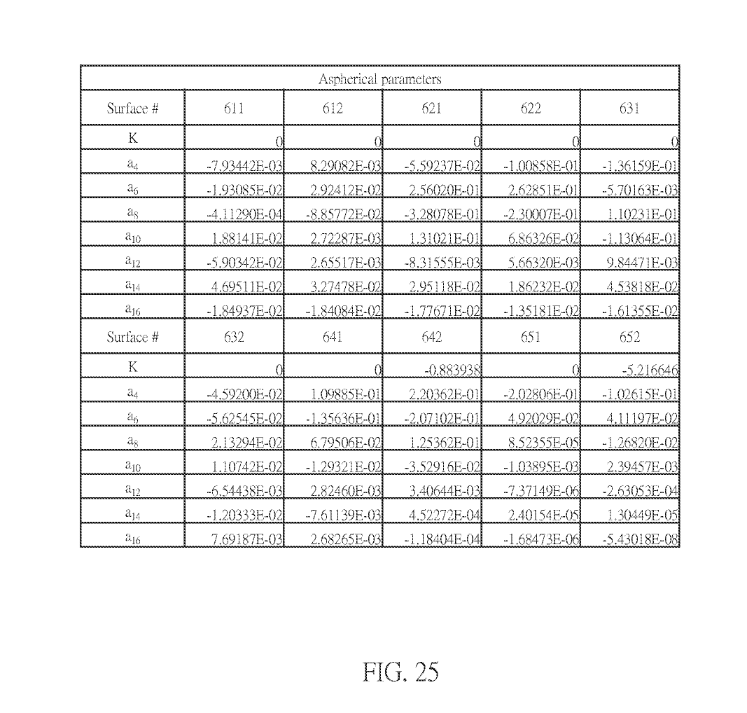

Reference is now made to FIGS. 22-25. FIG. 22 illustrates an example cross-sectional view of an optical imaging lens 6 having five lens elements of the optical imaging lens according to a sixth example embodiment. FIG. 23 shows example charts of longitudinal spherical aberration and other kinds of optical aberrations of the optical imaging lens 6 according to the sixth embodiment. FIG. 24 shows an example table of optical data of each lens element of the optical imaging lens 6 according to the sixth example embodiment. FIG. 25 shows an example table of aspherical data of the optical imaging lens 6 according to the sixth example embodiment. The reference numbers labeled in the present embodiment are similar to those in the first embodiment for the similar elements, but here the reference numbers are initialed with 6, for example, reference number 631 for labeling the object-side surface of the third lens element 630, reference number 632 for labeling the image-side surface of the third lens element 630, etc..

As shown in FIG. 22, the optical imaging lens 6 of the present embodiment, in an order from an object side A1 to an image side A2 along an optical axis, comprises an aperture stop 600, a first lens element 610, a second lens element 620, a third lens element 630, a fourth lens element 640 and a fifth lens element 650.

The differences between the sixth embodiment and the first embodiment are the radius of curvature and thickness of each lens element and the distance of each air gap, but the configuration of the positive/negative refracting power of the first, second, third, fourth and fifth lens elements 610, 620, 630, 640, 650 and configuration of the concave/convex shape of surfaces, comprising the object-side surfaces 611, 621, 631, 641, 651 facing to the object side A1 and the image-side surfaces 612, 622, 632, 642, 652 facing to the image side A2, are similar to those in the first embodiment. Please refer to FIG. 24 for the optical characteristics of each lens elements in the optical imaging lens 6 of the present embodiment, wherein the values of AG34/AG45, T2/AG45, AG23/AG34, T2/T5, T1/AG34, AAG/BFL, AG23/T2, ALT/T4, T3/AG34, AG34/BFL, T3/AG45, AAG/AG34, AG34/T5 are:

AG34/AG45=1.084;

T2/AG45=0.744;

AG23/AG34=1.006;

T2/T5=0.571;

T1/AG34=2.017;

AAG/BFL=1.009;

AG23/T2=1.467;

ALT/T4=3.391;

T3/AG34=1.077;

AG34/BFL=0.327;

T3/AG45=1.167;

AAG/AG34=3.084;

AG34/T5=0.833.

The distance from the object-side surface 611 of the first lens element 610 to the image plane 670 along the optical axis is 4.608 mm and the length of the optical imaging lens 6 is shortened. Thus, the optical imaging lens 6 is capable to provide excellent imaging quality for smaller sized mobile devices. Please noted that the f-number of the optical imaging lens 6 reaches 1.8.

As shown in FIG. 23, the optical imaging lens 6 of the present embodiment shows great characteristics in longitudinal spherical aberration (a), astigmatism in the sagittal direction (b), astigmatism in the tangential direction (c), and distortion aberration (d). Therefore, according to the above illustration, the optical imaging lens of the present embodiment indeed shows great optical performance and the length of the optical imaging lens 6 is effectively shortened.

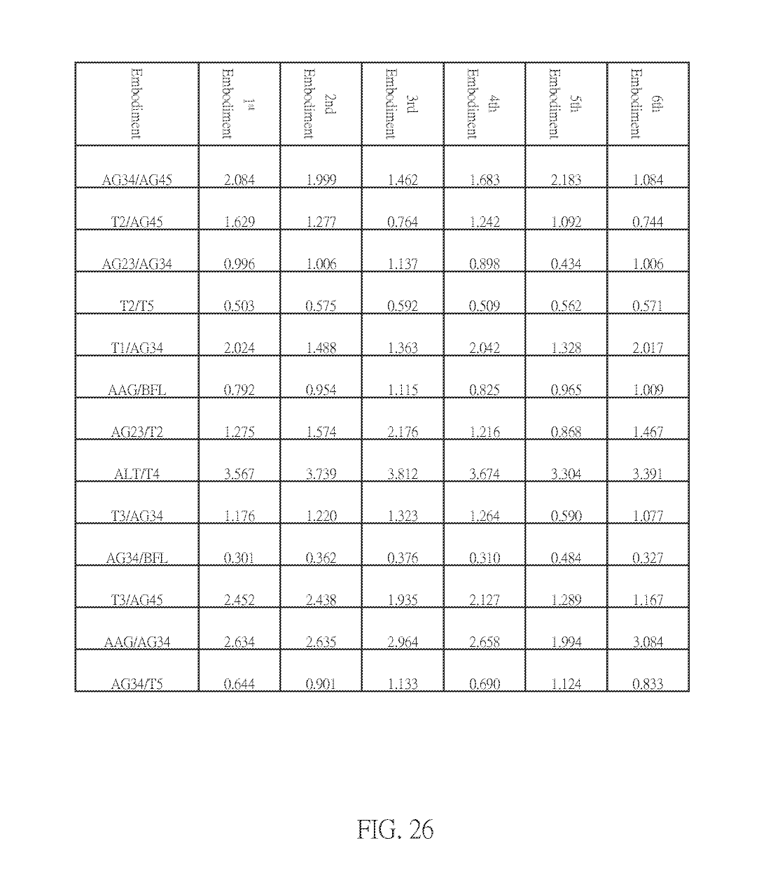

Please refer to FIG. 26, which shows the values of AG34/AG45, T2/AG45, AG23/AG34, T2/T5, T1/AG34, AAG/BFL, AG23/T2, ALT/T4, T3/AG34, AG34/BFL, T3/AG45, AAG/AG34, AG34/T5 of all six embodiments, and it is clear that the optical imaging lens of the present invention satisfy the Equations (1), (2), (3), (4), (5), (6), (7), (8), (9), (10), (11), (12) and/or (13).

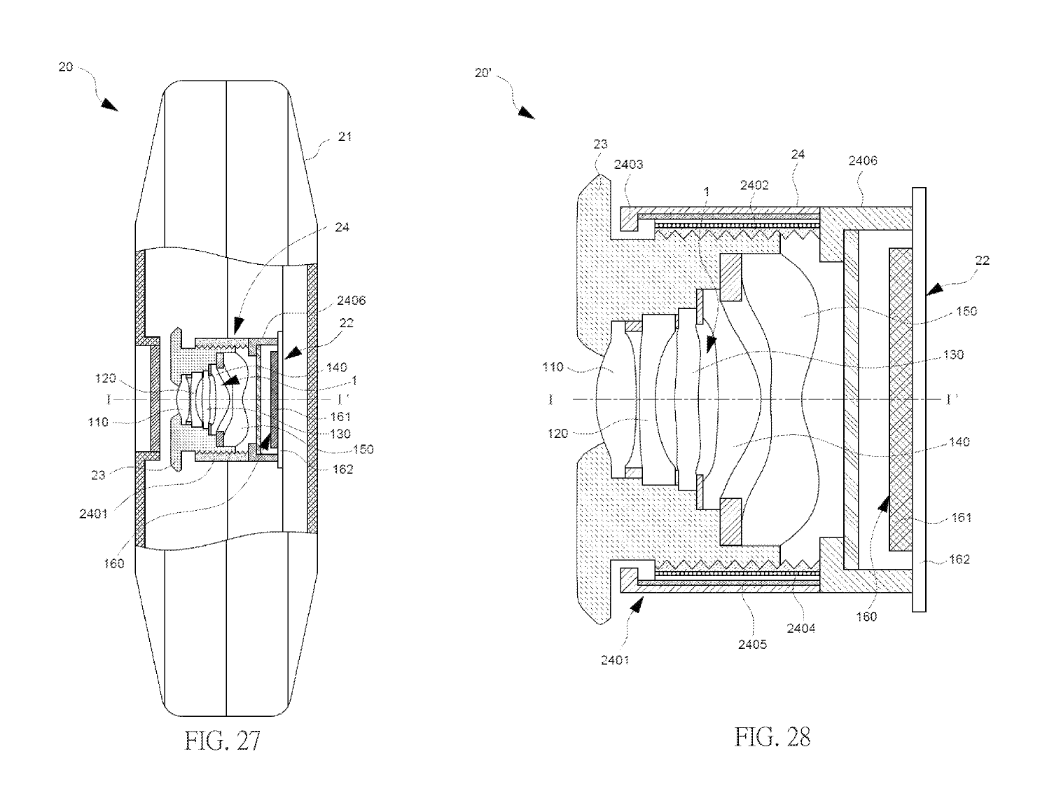

Reference is now made to FIG. 27, which illustrates an example structural view of a first embodiment of mobile device 20 applying an aforesaid optical imaging lens. The mobile device 20 comprises a housing 21 and a photography module 22 positioned in the housing 21. Examples of the mobile device 20 may be, but are not limited to, a mobile phone, a camera, a tablet computer, a personal digital assistant (PDA), etc..

As shown in FIG. 27, the photography module 22 may comprise an aforesaid optical imaging lens with five lens elements, which is a prime lens and for example the optical imaging lens 1 of the first embodiment, a lens barrel 23 for positioning the optical imaging lens 1, a module housing unit 24 for positioning the lens barrel 23, a substrate 172 for positioning the module housing unit 24, and an image sensor 171 which is positioned at an image side of the optical imaging lens 1. The image plane 170 is formed on the image sensor 171.

In some other example embodiments, the structure of the filtering unit 160 may be omitted. In some example embodiments, the housing 21, the lens barrel 23, and/or the module housing unit 24 may be integrated into a single component or assembled by multiple components. In some example embodiments, the image sensor 171 used in the present embodiment is directly attached to a substrate 172 in the form of a chip on board (COB) package, and such package is different from traditional chip scale packages (CSP) since COB package does not require a cover glass before the image sensor 171 in the optical imaging lens 1. Aforesaid exemplary embodiments are not limited to this package type and could be selectively incorporated in other described embodiments.

The five lens elements 110, 120, 130, 140, 150 are positioned in the lens barrel 23 in the way of separated by an air gap between any two adjacent lens elements.

The module housing unit 24 comprises a lens backseat 2401 for positioning the lens barrel 23 and an image sensor base 2406 positioned between the lens backseat 2401 and the image sensor 171. The lens barrel 23 and the lens backseat 2401 are positioned along a same axis I-I′, and the lens backseat 2401 is close to the outside of the lens barrel 23. The image sensor base 2406 is exemplarily close to the lens backseat 2401 here. The image sensor base 2406 could be optionally omitted in some other embodiments of the present invention.

Because the length of the optical imaging lens 1 is merely 4.671 mm, the size of the mobile device 20 may be quite small. Therefore, the embodiments described herein meet the market demand for smaller sized product designs.

Reference is now made to FIG. 28, which shows another structural view of a second embodiment of mobile device 20′ applying the aforesaid optical imaging lens 1. One difference between the mobile device 20′ and the mobile device 20 may be the lens backseat 2401 comprising a first seat unit 2402, a second seat unit 2403, a coil 2404 and a magnetic unit 2405. The first seat unit 2402 is close to the outside of the lens barrel 23, and positioned along an axis I-I′, and the second seat unit 2403 is around the outside of the first seat unit 2402 and positioned along with the axis I-I′. The coil 2404 is positioned between the first seat unit 2402 and the inside of the second seat unit 2403. The magnetic unit 2405 is positioned between the outside of the coil 2404 and the inside of the second seat unit 2403.

The lens barrel 23 and the optical imaging lens 1 positioned therein are driven by the first seat unit 2402 for moving along the axis I-I′. The rest structure of the mobile device 20′ is similar to the mobile device 20.

Similarly, because the length of the optical imaging lens 1, 4.671 mm, is shortened, the mobile device 20′ may be designed with a smaller size and meanwhile good optical performance is still provided. Therefore, the present embodiment meets the demand of small sized product design and the request of the market.

According to above illustration, it is clear that the mobile device and the optical imaging lens thereof in example embodiments, through controlling the detail structure of the lens elements and an inequality, the length of the optical imaging lens is effectively shortened and meanwhile good optical characteristics are still provided.

While various embodiments in accordance with the disclosed principles been described above, it should be understood that they are presented by way of example only, and are not limiting. Thus, the breadth and scope of exemplary embodiment(s) should not be limited by any of the above-described embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, a description of a technology in the “Background” is not to be construed as an admission that technology is prior art to any invention(s) in this disclosure. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. An optical imaging lens, sequentially from an object side to an image side along an optical axis, comprising an aperture stop, first, second, third, fourth and fifth lens elements, each of said first, second, third, fourth and fifth lens elements having refracting power, an object-side surface facing toward the object side and an image-side surface facing toward the image side and a central thickness defined along the optical axis, wherein:
said first lens element has positive refracting power, and said object-side surface thereof is a convex surface comprising a convex portion in a vicinity of the optical axis and a convex portion in a vicinity of a periphery of the first lens element;
said second lens element has negative refracting power, and said image-side surface thereof comprises a concave portion in a vicinity of a periphery of the second lens element;
said object-side surface of said third lens element comprises a convex portion in a vicinity of a periphery of the third lens element;
said fourth lens element has positive refracting power, and said object-side surface thereof comprises a concave portion in a vicinity of a periphery of the fourth lens element, and said image-side surface thereof is a convex surface comprising a convex portion in a vicinity of the optical axis and a convex portion in a vicinity of the periphery of the fourth lens element;
said image-side surface of said fifth lens element comprises a concave portion in a vicinity of the optical axis and a convex portion in a vicinity of a periphery of the fifth lens element;
the optical imaging lens comprises no other lenses having reflecting power beyond the five lens elements; and
an air gap between the third lens element and the fourth lens element along the optical axis is represented by AG34, an air gap between the fourth lens element and the fifth lens element along the optical axis is represented by AG45, and AG34 and AG45 satisfy the equation:
AG34/AG45≦2.2.

2. The optical imaging lens according to claim 1, wherein the central thickness of the second lens element is represented by T2, and T2 and AG45 satisfy the equation:
0.6≦T2/AG45.

3. The optical imaging lens according to claim 2, wherein an air gap between the second lens element and the third lens element along the optical axis is represented by AG23, and AG23 and AG34 satisfy the equation:
0.4≦AG23/AG34.

4. The optical imaging lens according to claim 3, wherein the central thickness of the fifth lens element is represented by T5, and T2 and T5 satisfy the equation:
0.5≦T2/T5.

5. The optical imaging lens according to claim 4, wherein the central thickness of the first lens element is represented by T1, and T1 and AG34 satisfy the equation:
1.3≦T1/AG34.

6. The optical imaging lens according to claim 5, wherein a sum of all four air gaps from the first lens element to the fifth lens element along the optical axis is represented by AAG, a back focal length of the optical imaging lens, which is defined as the distance from the image-side surface of the fifth lens element to an image plane along the optical axis, is represented by BFL, and AAG and BFL satisfy the equation:
0.79≦AAG/BFL.

7. The optical imaging lens according to claim 2, wherein the central thickness of the fifth lens element is represented by T5, and T2 and T5 satisfy the equation:
0.5≦T2/T5.

8. The optical imaging lens according to claim 7, wherein an air gap between the second lens element and the third lens element along the optical axis is represented by AG23, and T2 and AG23 satisfy the equation:
0.8≦AG23/T2.

9. The optical imaging lens according to claim 8, wherein the central thickness of the fourth lens element is represented by T4, a sum of the central thicknesses of all five lens elements is represented by ALT, and T4 and ALT satisfy the equation:
3.3≦ALT/T4.

10. The optical imaging lens according to claim 1, wherein an air gap between the second lens element and the third lens element along the optical axis is AG23, and AG23 and AG34 satisfy the equation:
0.4≦AG23/AG34.

11. The optical imaging lens according to claim 10, wherein the central thickness of the second lens element is represented by T2, the central thickness of the fifth lens element is represented by T5, and T2 and T5 satisfy the equation:
0.5≦T2/T5.

12. The optical imaging lens according to claim 11, wherein the central thickness of the third lens element is represented by T3, and T3 and AG34 satisfy the equation:
0.95≦T3/AG34.

13. The optical imaging lens according to claim 12, wherein a back focal length of the optical imaging lens, which is defined as the distance from the image-side surface of the fifth lens element to an image plane along the optical axis, is represented by BFL, and AG34 and BFL satisfy the equation:
0.3≦AG34/BFL.

14. The optical imaging lens according to claim 1, wherein the central thickness of the second lens element is represented by T2, the central thickness of the fifth lens element is represented by T5, and T2 and T5 satisfy the equation:
0.5≦T2/T5.

15. The optical imaging lens according to claim 14, wherein the central thickness of the third lens element is represented by T3, and T3 and AG45 satisfy the equation:
1≦T3/AG45.

16. The optical imaging lens according to claim 15, wherein a sum of all four air gaps from the first lens element to the fifth lens element along the optical axis is represented by AAG, and AG34 and AAG satisfy the equation:
2.6≦AAG/AG34.

17. The optical imaging lens according to claim 16, wherein T5 and AG34 satisfy the equation:
0.64≦AG34/T5.

18. A mobile device, comprising:
a housing; and
a photography module positioned in the housing and comprising:
an optical imaging lens, sequentially from an object side to an image side along an optical axis, comprising an aperture stop, first, second, third, fourth and fifth lens elements, each of said first, second, third, fourth and fifth lens elements having refracting power, an object-side surface facing toward the object side and an image-side surface facing toward the image side and a central thickness defined along the optical axis, wherein:
said first lens element has positive refracting power, and said object-side surface thereof is a convex surface comprising a convex portion in a vicinity of the optical axis and a convex portion in a vicinity of a periphery of the first lens element;
said second lens element has negative refracting power, and said image-side surface thereof comprises a concave portion in a vicinity of a periphery of the second lens element;
said object-side surface of said third lens element comprises a convex portion in a vicinity of a periphery of the third lens element;
said fourth lens element has positive refracting power, and said object-side surface thereof comprises a concave portion in a vicinity of a periphery of the fourth lens element, and said image-side surface thereof is a convex surface comprising a convex portion in a vicinity of the optical axis and a convex portion in a vicinity of the periphery of the fourth lens element;
said image-side surface of said fifth lens element comprises a concave portion in a vicinity of the optical axis and a convex portion in a vicinity of a periphery of the fifth lens element;
the optical imaging lens comprises no other lenses having reflecting power beyond the five lens elements; and
an air gap between the third lens element and the fourth lens element along the optical axis is represented by AG34, an air gap between the fourth lens element and the fifth lens element along the optical axis is represented by AG45, and AG34 and AG45 satisfy the equation:
AG34/AG45≦2.2;
a lens barrel for positioning the optical imaging lens;
a module housing unit for positioning the lens barrel; and
an image sensor positioned at the image side of the optical imaging lens.
